(19) United States
(12) Patent Application Publication
(10) Pub. No.: US 2006/0225450 A1
(43) Pub. Date: Oct. 12, 2006

(54) HYBRID-ELECTRIC VEHICLE WITH AUTOMATIC CLIMATE CONTROL STRATEGY

(75) Inventors: Gerhard A. Dage, Franklin, MI (US); Wayne Frank Buescher, Canton, MI (US); Thomas J. Fox, Livonia, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 11/279,374

(22) Filed: Apr. 11, 2006

Related U.S. Application Data
(60) Provisional application No. 60/670,456, filed on Apr. 12, 2005.

(51) Int. Cl. F25B 27/00; F25D 17/04; F25B 49/00; B60H 1/32

(52) U.S. Cl. 62/323.1; 62/239; 62/176.2; 62/228.1

(57) ABSTRACT

A method and system determine when a climate control system of a hybrid vehicle can be operated without use of its A/C compressor. The compressor is turned on to function when the compressor is coupled to an engine of the vehicle and the engine is running. The relative humidity inside the vehicle cabin is compared to a threshold to determine whether the compressor is required to function. If the engine is running and if the compressor is off, the compressor is turned on if the compressor is required to function. If the engine is running, the engine is turned off such that the compressor is turned off if the compressor is not required to function and if the vehicle is at idle. If the compressor was on, the compressor is turned off without turning off the engine if the compressor is not required and if the vehicle is being driven.

### CROSS-REFERENCE TO RELATED APPLICATIONS

This application claims the benefit of U.S. provisional application Ser. No. 60/670,456, filed Apr. 12, 2005, which is hereby incorporated by reference in its entirety.

This application is related to U.S. application Ser. No. 11/275,081, filed Dec. 8, 2005, entitled “Fuel Efficient Method and System for Hybrid Vehicles”, which is hereby incorporated by reference in its entirety.

### BACKGROUND OF THE INVENTION

1. Field of the Invention

The present invention relates to HVAC (heating, ventilation, and air conditioning) methods and systems for improving fuel economy and emissions of hybrid vehicles during mild ambient conditions.

2. Background Art

A typical HVAC system of a hybrid vehicle does not have the necessary inputs, processing power, and control strategies to make intelligent decisions as to when the engine and the A/C (air conditioning) compressor of the hybrid vehicle can be turned off. Turning off either the engine or the A/C compressor results in improved fuel economy and emissions. The typical HVAC system of a hybrid vehicle is not able to make an intelligent decision as to when the engine of the vehicle can be turned off in order to turn off the A/C compressor while the vehicle is at idle. Similarly, the typical HVAC system of a hybrid vehicle is not able to make an intelligent decision as to when to turn the A/C compressor off (without the engine of the vehicle being turned off) while the vehicle is being driven. Further, the typical HVAC system of a hybrid vehicle is not able to make an intelligent decision as to when to turn the A/C compressor off after fogging of the vehicle windows has been eliminated when the HVAC system is in a defogging mode (i.e., either a defrost or a floor/defrost mode).

As such, a problem associated with a hybrid vehicle having a typical HVAC system can be broken down into three operating conditions: 1) at idle (i.e., while the vehicle is at a stop); 2) during driving (i.e., while the vehicle is being driven); and 3) while the HVAC system is in a defogging mode regardless of whether the vehicle is idle or is being driven.

In the first operating condition in which the hybrid vehicle is at idle, the vehicle operates its engine whenever the A/C compressor has been requested in order to provide the cooling power necessary in the event it is required. Also, the A/C compressor is always requested when the HVAC system is in automatic mode whether or not the A/C compressor is required for comfort. As such, the engine is operated (i.e., turned on) while the vehicle is at idle because, as indicated above, the HVAC system is not able to make an intelligent decision as to when the engine can be turned off (and thus the A/C compressor will be turned off) to thereby improve fuel economy and emissions.

In the second operating condition in which the hybrid vehicle is being driven, the vehicle operates the A/C compressor in order to provide the cooling power necessary in the event it is required. Also, the A/C compressor is always requested when the HVAC system is in automatic mode whether or not the A/C compressor is required for comfort. As such, the A/C compressor is operated (i.e., turned on) while the vehicle is being driven because, as indicated above, the HVAC system is not able to make an intelligent decision to turn the A/C compressor off (while the engine remains on and operated) to thereby improve fuel economy and emissions.

In the third operating condition, the HVAC system of the hybrid vehicle is in defogging mode (i.e., in either defrost or floor/defrost mode). When the HVAC system is in defogging mode, the A/C compressor is requested in order to defog the vehicle windows. As such, the A/C compressor is operated (i.e., turned on) while the HVAC system is in defogging mode even after the fogging has been eliminated because, as indicated above, the HVAC system is not able to make an intelligent decision to turn the A/C compressor off to thereby improve fuel economy and emissions.

### SUMMARY OF THE INVENTION

In general, the present invention provides a method and system for determining when it is possible to operate the climate control HVAC system of a hybrid vehicle without the use of the A/C compressor and still maintain comfort to thereby improve fuel economy and emissions.

The method and system of the present invention use multiple inputs, timers, and look-up tables as factors coupled with novel strategies to determine when it is possible to operate the HVAC system of a hybrid vehicle without the use of the A/C compressor and still maintain comfort. The purposes of this determination include: 1) being able to shut off the engine of the vehicle (and thereby shut off the A/C compressor) while the vehicle is at idle (i.e., while the vehicle is at a stop) to thereby improve fuel economy and emissions; 2) being able to shut off the A/C compressor while the vehicle is being driven to thereby improve fuel economy and emissions; and 3) being able to turn on the A/C compressor, while the HVAC system is in defogging mode (i.e., in either defrost or floor/defrost mode), only when the A/C compressor is required to eliminate the fogging to thereby improve fuel economy and emissions.

In operation, after the A/C compressor has operated for a period of time, the HVAC ‘system’ calculates the dewpoint of the interior surface of a vehicle window(s) (e.g., a windshield). The calculated dewpoint is indicative of the probability of fogging of the window. This calculation is based on input from a humidity sensor associated with the window. The HVAC ‘system’ also monitors other variables such as relative humidity (RH) inside the vehicle cabin, ambient temperature (Tamb), vehicle speed, evaporator temperature (Tevap), and blend door positions. The HVAC ‘system’ may also monitor other variables such as run time duty cycle of the A/C compressor, engine value average (EngValAvg), engine set temperature (EngSetTemp), and engine discharge air temperature (EngTdis).

When the vehicle comes to a stop (i.e., at idle) and when the vehicle is being driven, the method and system compare the values of the monitored conditions to reference values in accordance with flow strategies to determine whether or not the A/C compressor is required to function in order to maintain comfort or to defog the vehicle window. If the A/C compressor is not required to maintain comfort or to defog the vehicle window, the method and system turn off the A/C compressor until such time that the monitored conditions as specified in the flow strategies necessitate operation of the A/C compressor.

Briefly, the method and system compare the relative humidity of the vehicle cabin to relative humidity reference values in accordance with the flow strategies to determine the amount of contribution the A/C compressor is adding to comfort. If it is determined that the A/C compressor is having a negligible impact on comfort, the method and system turn off the A/C compressor. Likewise, the method and system compare the fog probability of the vehicle window to fog probability reference values in accordance with the flow strategies to determine whether fogging of the vehicle window is present or absent. If it is determined that the fogging has been eliminated while the HVAC system is in defogging mode, the method and system turn off the A/C compressors. That is, the method and system turn on the A/C compressor, while the HVAC system is in defogging mode, only when the A/C compressor is required to eliminate the vehicle window fogging i.e., only when fogging is present while the HVAC system is in defogging mode).

The advantages associated with the method and system include improving fuel economy and tailpipe emissions by: 1) turning the engine off (and thereby turning the A/C compressor off) while the vehicle is at idle when the A/C compressor is having a negligible impact on comfort; 2) turning the A/C compressor off while the vehicle is being driven when the A/C compressor is having a negligible impact on comfort; and 3) turning on the A/C compressor only when the A/C compressor is required to eliminate vehicle window fogging while the HVAC system is in defogging mode.

In one embodiment, the present invention provides a method for operating a climate control system of a hybrid vehicle without the use of an A/C compressor of the climate control system. The A/C compressor is turned on to function when the A/C compressor is coupled to an engine of the hybrid vehicle and the engine is running. The method includes determining whether the hybrid vehicle is at idle or is being driven, determining whether the engine of the hybrid vehicle is running, and monitoring relative humidity (and/or fog probability) inside the cabin of the vehicle. Whether or not the A/C compressor is required to function is determined by comparing the monitored relative humidity (and/or fog probability) to a threshold. The A/C compressor is determined to be required to function if the monitored relative humidity (and/or fog probability) is less than the threshold. If the engine is running and if the A/C compressor is off, the A/C compressor is turned on if the A/C compressor is required to function. The A/C compressor is determined to not be required to function if the monitored relative humidity (and/or fog probability) is greater than the threshold. If the engine is running, the engine is turned off such that the A/C compressor is turned off if the A/C compressor is not required to function and if the vehicle is at idle. If the A/C compressor was on, the A/C compressor is turned off without turning off the engine if the A/C compressor is not required to function and if the vehicle is being driven.

In another embodiment, the present invention provides a climate control system of a hybrid vehicle. The system includes an A/C compressor which couples to an engine of a hybrid vehicle when the engine is on in order to function. The system further includes a controller for determining whether the hybrid vehicle is at idle or is being driven and whether the engine of the hybrid vehicle is running. The controller determines whether the A/C compressor is required to function by comparing relative humidity (and/or fog probability) monitored inside the vehicle cabin to a threshold. The controller determines that the A/C compressor is required to function if the monitored relative humidity (and/or fog probability) is less than the threshold and determines that the A/C compressor is not required to function if the monitored relative humidity (fog probability) is greater than the threshold. If the engine is running and if the A/C compressor is off, the controller turns on the A/C compressor if the A/C compressor is required to function. If the engine is running, the controller turns off the engine such that the A/C compressor is turned off if the A/C compressor is not required to function and if the vehicle is at idle. If the A/C compressor was on, the controller turns off the A/C compressor without turning off the engine if the A/C compressor is not required to function and if the vehicle is being driven.

Further advantages, objectives and features of the present invention will become apparent from the following detailed description and the accompanying figures disclosing illustrative embodiments of the present invention.

### BRIEF DESCRIPTION OF THE DRAWINGS

FIG. 1 illustrates a heating, ventilation, and air conditioning (HVAC) system of a hybrid vehicle which is controllable in accordance with the present invention;

FIG. 2 illustrates a block diagram of an HVAC system controller in accordance with the present invention;

FIG. 3 illustrates a flow chart describing operation of a flow strategy for deciding when to keep the engine of a hybrid vehicle running for A/C compressor operation in accordance with the present invention;

FIG. 4 illustrates a flow chart describing operation of a flow strategy for deciding when to command the engine of a hybrid vehicle to start running for A/C compressor operation in accordance with the present invention;

FIG. 5 illustrates a flow chart describing operation of a flow strategy for deciding when to keep the A/C compressor of a hybrid vehicle running in accordance with the present invention; and

FIG. 6 illustrates a flow chart describing operation of a flow strategy for deciding when to command the A/C compressor of a hybrid vehicle to start running in accordance with the present invention.

### DETAILED DESCRIPTION OF THE PREFERRED EMBODIMENT(S)

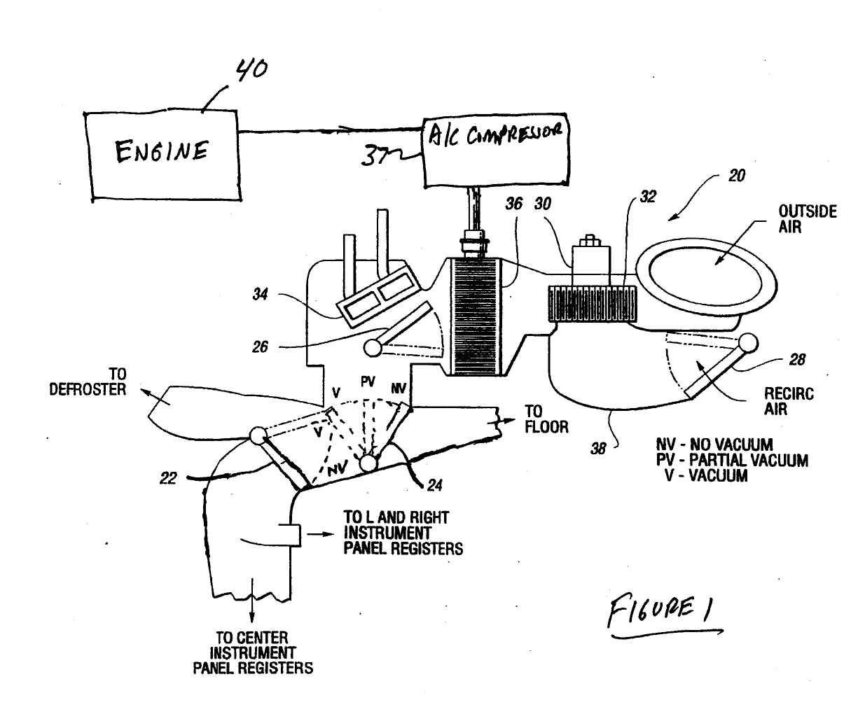

Referring now to FIG. 1, a heating, ventilation, and air conditioning (HVAC) system 20 of a hybrid vehicle controllable by the method and system of the present invention is shown. HVAC system 20 includes an arrangement of defrost, floor, temperature blend, and outside recirculation doors 22, 24, 26, and 28. Doors 22 and 24 are preferably driven by vacuum motors between their various vacuum, partial vacuum, and no vacuum positions as indicated by FIG. 1. Doors 26 and 28 are driven by electric servo motors so that their positions are continuously variable.

HVAC system 20 includes a variable speed motor 30 having a blower wheel 32. HVAC system 20 includes heating and cooling elements such as a heater core 34 and an evaporator core 36 in a vehicle air conditioning plant. The evaporator temperature is controlled to allow HVAC system 20 to dehumidify air passing thereover.

The air conditioning plant includes an A/C compressor 37 which is selectively coupled to engine 40 of the hybrid vehicle by a control element such as an A/C clutch. The air conditioning plant may include a condenser, a refrigerant tank, pressure cycling switch, and an expansion orifice or capillary.

Each of the above components are connected via ducting 38. In this way, the above components control temperature, the direction of air flow, and the ratio of fresh air to recirculated air.

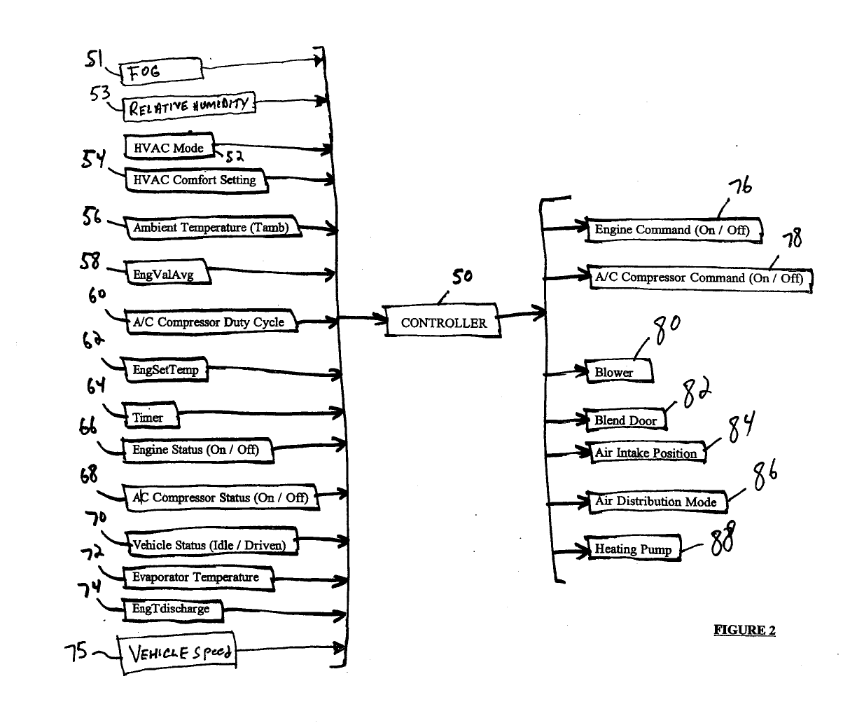

Referring now to FIG. 2, with continual reference to FIG. 1, a block diagram of an HVAC system controller 50 in accordance with the present invention is shown. Controller 50 uses inputs, timers, and look-up tables as factors coupled with flow strategies for determining when it is possible to operate HVAC system 20 without the use of A/C compressor 37 and still maintain comfort. That is, controller 50 determines when engine 40 (and thereby A/C compressor 37) can be shut off while the vehicle is at idle to thereby improve fuel economy and emissions; the controller determines when the A/C compressor can be shut off (will not turn off the engine) while the vehicle is being driven to thereby improve fuel economy and emissions; and the controller determines when to shut off the A/C compressor while the HVAC system is in defogging mode (conversely, the controller determines when to turn on the A/C compressor while the HVAC system in defogging mode such that the A/C is turned on only when it is required to eliminate vehicle window fogging).

The inputs to controller 50 include vehicle window humidity sensor input 51 (i.e., vehicle window fog probability indicator), HVAC system mode setting 52, vehicle cabin relative humidity input 53, HVAC system comfort mode setting 54, ambient temperature (Tamb) 56, engine value average (EngValAvg) 58, A/C compressor duty cycle 60, engine set temperature (EngSetTemp) 62, timer 64, engine status (on/off) 66, A/C compressor status (on/off) 68, vehicle status (idle/driven) 70, evaporator temperature 72 (Tevap), engine discharge air temperature (EngTdischarge) 74, and vehicle speed 75.

Vehicle window humidity sensor input 51 is generated by a humidity sensor associated with a vehicle window. This humidity sensor is operable to sense the dewpoint of the interior surface of the vehicle window. The dewpoint is indicative of the probability of vehicle window fogging. Vehicle cabin relative humidity input 53 is generated by a humidity sensor inside the vehicle cabin. This humidity sensor senses the humidity inside the vehicle cabin relative to the outside vehicle environment to generate the vehicle cabin relative humidity input (% R.H.). The two sensors may be incorporated as a single sensor operable to provide the two sensor inputs 51, 53.

HVAC system 20 has different operating modes such as maximum A/C mode, defrost modes (defrost, floor/defrost) for vehicle window fog elimination, automatic mode, and other manual modes (panel, panel/floor, floor). HVAC system mode setting input 52 is indicative of the mode that HVAC system 20 is in at any given time.

For each operating mode, HVAC system 20 provides different levels of comfort. A first level of comfort provides minimum comfort for any given operating mode; and a second level of comfort provides maximum comfort for any given operating mode. The comfort settings for the operating modes of HVAC system 20 are service/customer selectable. The comfort settings are adjustable with multiple button presses on a front panel of HVAC system 20 or with dealer diagnostic tools. In general, each operating mode of HVAC system 20 has four comfort settings (“0”, “1”, “2”, and “3”). Setting “0” turns off the comfort (i.e., the engine is shut off at a vehicle stop); setting “1” provides minimum comfort action; setting “2” is an initial factory setting; and setting “3” provides maximum comfort action. HVAC system comfort mode setting input 54 is indicative of the comfort setting that HVAC system 20 is in at any given time.

Ambient temperature (Tamb) input 56 is indicative of the temperature inside of the vehicle cabin. Engine value average, engine set temperature, and engine discharge air temperature (EngTdis) inputs 58, 62, and 74 are indicative of operating conditions of engine 40. A/C compressor duty cycle input 60 is indicative of the run time duty cycle of A/C compressor 37 as the A/C compressor couples to engine 40 over a given period of time for providing air conditioning operations. Timer input 64 is indicative of a running total of time from a given initial starting point. Engine status input 66 is indicative of whether engine 40 is on or off while the vehicle is at idle (the engine will be on while the vehicle is being driven). A/C compressor status input 68 is indicative of whether A/C compressor 37 is on or off while the vehicle is at idle or is being driven (the A/C compressor will be off while the engine is off). Vehicle status input 70 is indicative of whether the vehicle is at a stop (i.e., idle) or whether the vehicle is being driven. Evaporator temperature (Tevap) input 74 is indicative of the temperature of the evaporator temperature.

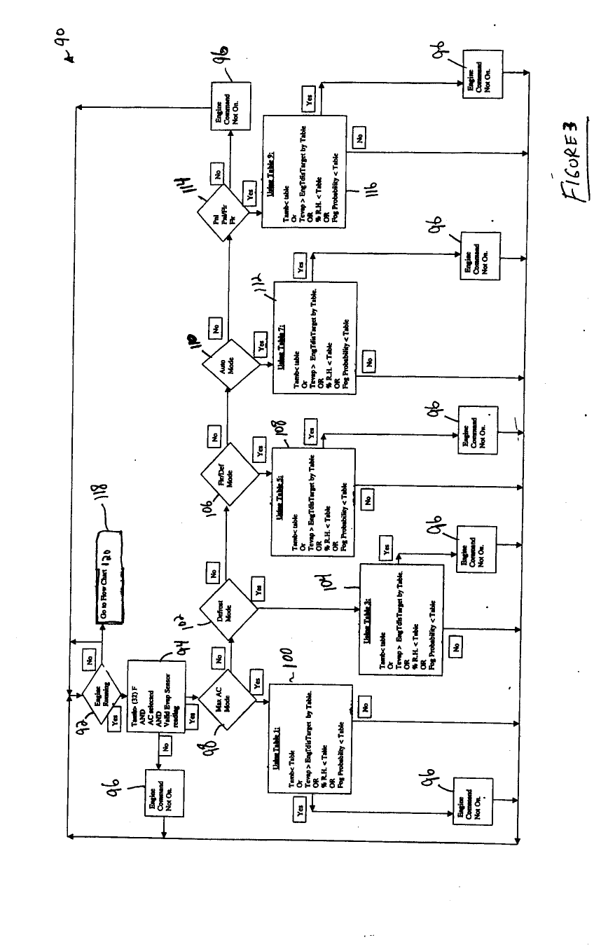

As indicated above, controller 50 processes the inputs and uses look-up tables in accordance with flow strategies (described in detail with reference to FIGS. 3, 4, 5, and 6) for determining when it is possible to operate HVAC system 20 without the use of A/C compressor 37 and still maintain comfort. Based on its determinations, controller 50 provides command outputs for controlling A/C compressor 37 and engine 40; and provides climate action outputs for controlling other elements of HVAC system 20 to delay loss of cooling comfort when the A/C compressor is shut off.

More specifically, depending on its determinations, controller provides: an engine “on” command 76 which causes engine 40 to continue running (while the vehicle is idle or is being driven) or to start running (while the vehicle is idle); an engine “off” command 76 which causes the engine to stop running (while the vehicle is idle) or to refrain from starting to run (while the vehicle is idle); an A/C compressor “on” command 78 which causes A/C compressor 37 to continue running (while the vehicle is idle or is being driven) or to start running (while the vehicle is idle or is being driven); and an A/C compressor “off” command 78 which causes the A/C compressor to stop running (while the vehicle is idle or is being driven) or to refrain from starting to run (while the vehicle is idle or is being driven). An engine “off” command 76 causes both A/C compressor 37 and engine 40 to be turned off; and an engine “on” command causes both of the A/C compressor and the engine to be turned on.

Upon outputting a command to cause A/C compressor 37 to be turned off, controller 50 outputs climate action outputs for controlling other elements of HVAC system 20 to delay loss of cooling comfort as a result of the A/C compressor being turned off. The climate action outputs include blower speed 80, blend door 82, air intake position 84, air distribution mode 86, and heating pump 88 outputs. Blower speed output 80 causes no changes to manual blower speed selections for blower wheel 32, but adds filters to the auto blower operation. Blend door position output 82 causes temperature blend door 26 to be driven to toward full cold action. Air intake position output 84 defaults auto recirculation to the outside, but causes no changes to manual recirculation. Air distribution mode output 86 causes no changes. Heating pump output 88 provides a request to turn off warm Tambient.

Referring now to FIG. 3, with continual reference to FIGS. 1 and 2, a flow chart 90 describing operation of a flow strategy employed by controller 50 for deciding when to keep engine 40 running for operation of A/C compressor 37 is shown.

Initially, controller 50 processes engine status input 66 to determine whether engine 40 is running as shown in decision block 92. If engine 40 is running, then controller 50 processes HVAC mode input 52, ambient temperature (Tamb) input 56, and evaporator temperature (Tevap) input 72 to respectively determine if “AC” is selected, if the ambient temperature is at least 32° F., and if the evaporator temperature is a valid reading as shown in decision block 94. If at least one of these conditions is false (i.e., not satisfied), then controller 50 outputs either an engine “off” command 76 (if the vehicle is idle) or an A/C compressor “off” command 78 (if the vehicle is being driven) as shown in block 96. The net result is that A/C compressor 37 and engine 40 are both turned off if the vehicle is idle or the A/C compressor is turned off (while the engine remains running) if the vehicle is being driven. The process then repeats by returning to decision block 92.

If all three conditions are true (i.e., satisfied) in decision block 94, then controller 50 processes HVAC mode input 52 to determine the mode of HVAC system 20. As indicated above, the modes of HVAC system 20 include maximum A/C mode, defrost modes (defrost and floor/defrost modes), automatic mode, manual modes (panel, panel/floor, and floor modes).

If controller 50 determines that HVAC system 20 is in the maximum A/C mode at decision block 98, then the controller processes HVAC comfort setting input 54 to determine the comfort setting (“0”, “1” , “2” , or “3”) of HVAC system 20. In general, controller 50 compares various inputs (namely, ambient temperature (Tamb) input 56, evaporator temperature (Tevap) input 72, engine discharge temperature (EngTdis) input 74, relative humidity (% R.H.) input 53, and fog probability input 51) with reference values set forth in the following Table 1 to determine whether or not to keep engine 40 running for operation of A/C compressor 37. The reference values depend on the comfort setting of HVAC system 20.

TABLE 1
(Maximum A/C Mode)

| | | | Tevap by (° F.) > | |
|---|---|---|---|---|
| Comfort Set. | Tamb(° F.) | % R.H. | EngTdisTarget | Fog Prob. |
| 0 | 70 | 55% | 0 | 70% |
| 1 | 65 | 50% | −5 | 65% |
| 2 | 60 | 45% | −10 | 60% |
| 3 | 50 | 40% | −15 | 55% |

In decision block 100, controller 50 determines whether ambient temperature (Tamb) input 56 is less than the reference Tamb value listed in Table 1 for the comfort setting of HVAC system 20. For example, if the comfort setting of HVAC system 20 is “1”, then controller 50 determines whether ambient temperature input 56 is less than 650F; similarly, if the comfort setting is “3”, then the controller determines whether the ambient temperature input is less than 50° F. Further, in decision block 100, controller 50 compares evaporator temperature (Tevap) input 72 to engine discharge temperature (EngTdis) input 74 to determine if the evaporator temperature is at least greater in ° F. than the engine discharge temperature by a reference value listed in Table 1 for the comfort setting. For example, if the comfort setting is “2”, then controller 50 determines whether Tevap is greater than EngTdis by at least −10° F. Further, in decision block 100, controller 50 determines whether relative humidity (% R.H.) input 53 is less than the reference relative humidity (% R.H.) value listed in Table 1 for the comfort setting of HVAC system 20. For example, if the comfort setting is “1”, then controller 50 determines whether relative humidity (% R.H.) input 53 is less than 50%. Further, in decision block 100, controller 50 determines whether fog probability input 51 is less than the reference fog probability value listed in Table 1 for the comfort setting of HVAC system 20. For example, if the comfort setting “3”, then controller 50 determines whether fog probability input is less than 55%. If anyone of the four comparisons is true in decision block 100 (i.e, either the ambient temperature comparison, the evaporator temperature comparison, the relative humidity (% R.H.) comparison, or the fog probability comparison is true), then controller 50 outputs either an engine “off” command 76 (if the vehicle is idle) or an A/C compressor “off” command 78 (if the vehicle is being driven) as shown in block 96 and the process then repeats by returning to decision block 92. If none of the four comparisons are true in decision block 100, then the process returns to decision block 92.

If controller 50 determines that HVAC system 20 is not in the maximum A/C mode in decision block 98, then the controller determines whether the HVAC system is in the defrost mode in decision block 102. In the defrost mode, HVAC system 20 is able to perform vehicle window defogging. If controller 50 determines that HVAC system 20 is in the defrost mode, then the controller processes HVAC comfort setting input 54 to determine the comfort setting of HVAC system 20. In general, controller 50 compares the various noted inputs with reference values set forth in the following Table 3 to determine whether or not to keep engine 40 running for operation of A/C compressor 37.

TABLE 3
(Defrost Mode)

| | | | Tevap by (° F.) > | |
|---|---|---|---|---|
| Comfort Set. | Tamb(° F.) | % R.H. | EngTdisTarget | Fog Prob. |
| 0 | 27 | 20% | 5 | 5% |
| 1 | 27 | 20% | −5 | 5% |
| 2 | 27 | 20% | −10 | 5% |
| 3 | 27 | 20% | −15 | 5% |

Controller 50 then proceeds processing the various inputs in the manner as described with respect to the maximum A/C mode except that reference values of Table 3 are used instead of the Table 1 reference values. Particularly, in decision block 104, controller 50 determines whether Tamb input 56 is less than the reference Tamb value listed in Table 3 for the comfort setting of HVAC system 20, whether Tevap input 72 is at least greater in ° F. than the engine discharge temperature input 74 by a reference value listed in Table 3 for the comfort setting, whether the relative humidity input 53 is less than the reference relative humidity value listed in Table 3 for the comfort setting, or whether fog probability input 51 is less than the reference fog probability value listed in Table 3 for the comfort setting. If in decision block 104 any of these four comparisons is true, then controller 50 outputs either an engine “off” command 76 (if the vehicle is idle) or an A/C compressor “off” command 78 (if the vehicle is being driven) as shown in block 96 and the process returns to decision block 92. If none of these four comparisons are true in decision block 104, then the process returns to decision block 92.

If controller 50 determines that HVAC system 20 is not in the defrost mode in decision block 102, then the controller determines whether the HVAC system is in the floor/defrost mode in decision block 106. In the floor/defrost mode, HVAC system 20 is able to perform vehicle window defogging. If controller 50 determines that HVAC system 20 is in the floor/defrost mode, then the controller processes HVAC comfort setting input 54 to determine the comfort setting of HVAC system 20. In general, controller 50 compares the various noted inputs with reference values set forth in the following Table 5 to determine whether or not to keep engine 40 running for operation of A/C compressor 37.

TABLE 5
(Floor/Defrost Mode)

| | | | Tevap by (° F.) > | |
|---|---|---|---|---|
| Comfort Set. | Tamb(° F.) | % R.H. | EngTdisTarget | Fog Prob. |
| 0 | 27 | 20% | 5 | 5% |
| 1 | 27 | 20% | −5 | 5% |
| 2 | 27 | 20% | −10 | 5% |
| 3 | 27 | 20% | −15 | 5% |

Controller 50 then proceeds processing the various inputs in the manner as described with respect to the maximum A/C mode except that reference values of Table 5 are used instead of the Table 1 reference values. Particularly, in decision block 108, controller 50 determines whether Tamb input 56 is less than the corresponding reference Tamb value listed in Table 5, whether the Tevap input 72 is at least greater in ° F. than the engine discharge temperature input 74 by a corresponding reference value listed in Table 5, whether the relative humidity input 53 is less than the corresponding reference relative humidity value listed in Table 5, or whether fog probability input 51 is less than the corresponding reference fog probability value listed in Table 5. If in decision block 108 any of these four comparisons is true, then controller 50 outputs either an engine “off” command 76 (if the vehicle is idle) or an A/C compressor “off” command 78 (if the vehicle is being driven) as shown in block 96 and the process then returns to decision block 92. If none of the comparisons are true, then the process returns to decision block 92.

If controller 50 determines that HVAC system 20 is not in the floor/defrost mode in decision block 106, then the controller determines whether the HVAC system is in the automatic mode in decision block 110. If controller 50 determines that HVAC system 20 is in the automatic mode, then the controller processes HVAC comfort setting input 54 to determine the comfort setting of HVAC system 20. In general, controller 50 compares the various noted inputs with reference values set forth in the following Table 7 to determine whether or not to keep engine 40 running for operation of A/C compressor 37.

TABLE 7
(Automatic Mode)

| | | | Tevap by (° F.) > | |
|---|---|---|---|---|
| Comfort Set. | Tamb(° F.) | % R.H. | EngTdisTarget | Fog Prob. |
| 0 | 70 | 55% | 10 | 70% |
| 1 | 65 | 50% | 0 | 65% |
| 2 | 60 | 45% | −10 | 60% |
| 3 | 50 | 40% | −15 | 55% |

Controller 50 then proceeds processing the various inputs in the manner as described with respect to the maximum A/C/mode except that reference values of Table 7 are used instead of Table 1 reference values. Particularly, in decision block 112, controller 50 determines whether Tamb input 56 is less than the corresponding reference Tamb value listed in Table 7, whether the Tevap input 72 is at least greater in ° F. than the engine discharge temperature input 74 by a corresponding reference value listed in Table 7, whether the relative humidity input 53 is less than the corresponding reference relative humidity value listed in Table 7, or whether fog probability input 51 is less than the corresponding reference fog probability value listed in Table 7. If in decision block 112 any one of these four comparisons are true, then controller 50 outputs either an engine “off” command 76 (if the vehicle is idle) or an A/C compressor “off” command 78 (if the vehicle is being driven) as shown in block 96 and the process returns to decision block 92. If none of the comparisons are true, then the process returns to decision block 92.

If controller 50 determines that HVAC system 20 is not in the automatic mode in decision block 110, then the controller determines whether the HVAC system is in either the panel, panel/floor, or the floor mode in decision block 114. If controller 50 determines that HVAC system 20 is in either the panel, panel/floor, or the floor mode, then the controller processes HVAC comfort setting input 54 to determine the comfort setting of HVAC system 20. In general, controller 50 compares the various noted inputs with reference values set forth in the following Table 9 to determine whether or not to keep engine 40 running for operation of A/C compressor 37.

TABLE 9
(Panel, Panel/Floor, Floor Modes)

| | | | Tevap by (° F.) > | |
|---|---|---|---|---|
| Comfort Set. | Tamb(° F.) | % R.H. | EngTdisTarget | Fog Prob. |
| 0 | 70 | 60% | 10 | 70% |
| 1 | 65 | 55% | 0 | 65% |
| 2 | 60 | 50% | −10 | 60% |
| 3 | 50 | 45% | −15 | 55% |

Controller 50 then proceeds processing the various inputs in the manner as described with respect to the maximum A/C mode except that Table 9 reference values are used instead of Table 1 reference values. Particularly, in decision block 116, controller 50 determines whether Tamb input 56 is less than the corresponding reference Tamb value listed in Table 9, whether Tevap input 72 is at least greater in ° F. than the engine discharge temperature input 74 by a corresponding reference value listed in Table 9, whether relative humidity input 53 is less than the corresponding reference relative humidity value listed in Table 9, or whether fog probability input 51 is less than the corresponding reference fog probability value listed in Table 9. If in decision block 112 any one of these four comparisons are true, then controller 50 outputs either an engine “off” command 76 (if the vehicle is idle) or an A/C compressor “off” command 78 (if the vehicle is being driven) as shown in block 96 and the process returns to decision block 92. If none of the comparisons are true in decision block 116, then the process returns to decision block 92.

If controller 50 determines that HVAC system 20 is not in either the panel, panel/floor, or floor mode in decision block 114, then the controller outputs either an engine “off” command 76 (if the vehicle is idle) or an A/C compressor “off” command 78 (if the vehicle is being driven) as shown in block 96 and the process then returns to decision block 92.

It is noted that Tables 1, 3, 5, 7, and 9 have thus been described so far. Similar Tables 2, 4, 6, 8, and 10-20 will be described. The following regarding all the Tables is noted: all Tables range of reference values for Tamb=20° F. to 100° F. with increments of 2° F.; all Tables range of reference values for % R.H.=20% to 100% with increments of 2%; all Tables range of reference values for Tevap>EngTdisTarget is −50° F. to 50° F. with increments of 2° F.; and all Tables range of reference values for fog probability is 10% to 100% with increments of 2%. The reference values listed in the Tables are placeholders.

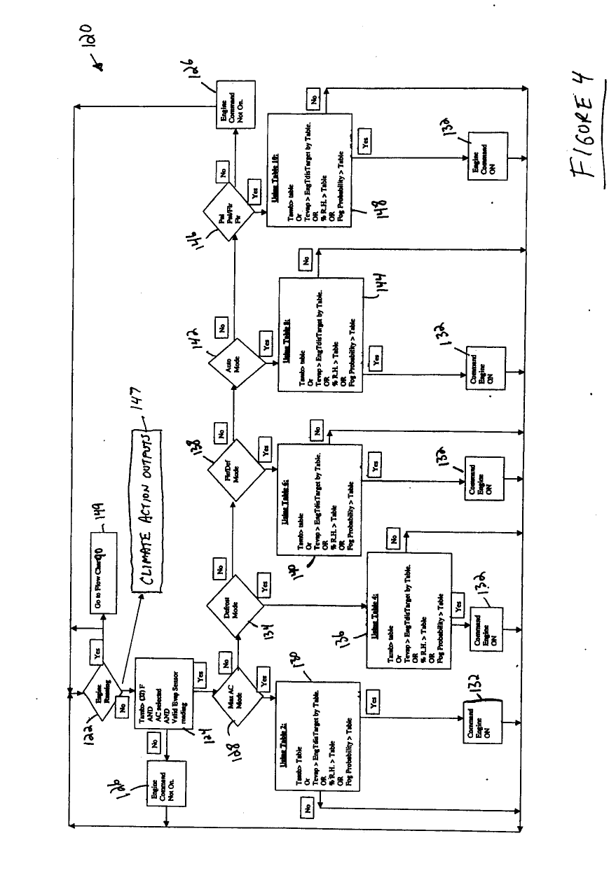

If controller 50 determines at decision block 92 that engine 40 is not running, then the controller proceeds at block 118 to flow chart 120 (shown in FIG. 4) to determine whether to command the engine to start running for operation of the A/C compressor.

Referring now to FIG. 4, with continual reference to FIGS. 1 and 2, a flow chart 120 describing operation of a flow strategy employed by controller 50 for deciding when to command engine 40 to start running for operation of A/C compressor 37 is shown.

Initially, controller 50 processes engine status input 66 to determine whether engine 40 is running as shown in decision block 122. If engine 40 is not running, then controller 50 processes HVAC mode input 52, ambient temperature (Tamb) input 56, and evaporator temperature (Tevap) input 72 to respectively determine if “AC” is selected, if the ambient temperature is at least 32° F., and if the evaporator temperature is a valid reading as shown in decision block 124. If at least one of these conditions is false, then controller 50 outputs an engine “off” command 76 as shown in block 126. The net result is that engine 40 (and thereby A/C compressor 37) remain turned off. The process then returns to decision block 122.

If “AC” is selected, Tamb is at least 32° F., and the Tevap reading is valid in decision block 124, then controller 50 processes HVAC mode input 52 to determine the mode of HVAC system 20.

If controller 50 determines that HVAC system 20 is in the maximum A/C mode in decision block 128, then the controller processes HVAC comfort setting input 54 to determine the comfort setting of HVAC system 20. In general, controller 50 compares the various noted inputs (Tamb input 56, Tevap input 72, EngTdis input 74, relative humidity (% R.H.) input 53, and fog probability input 51) with reference values set forth in the following Table 2 to determine whether to command engine 40 to start running for operation of A/C compressor 37.

TABLE 2
(Maximum A/C Mode)

| | | | Tevap by (° F.) > | |
|---|---|---|---|---|
| Comfort Set. | Tamb(° F.) | % R.H. | EngTdisTarget | Fog Prob. |
| 0 | 80 | 70% | 20 | 80% |
| 1 | 75 | 65% | 15 | 75% |
| 2 | 70 | 60% | 10 | 70% |
| 3 | 60 | 55% | 5 | 65% |

As such, in decision block 130, controller 50 determines whether Tamb input 56 is greater than the reference Tamb value listed in Table 2 for the comfort setting of HVAC system 20. For example, if the comfort setting of HVAC system 20 is “1”, then controller 50 determines whether Tamb input 56 is greater than 75° F. Further, in decision block 130, controller 50 compares Tevap input 72 to EngTdis input 74 to determine if Tevap is at least greater in ° F. than the EngTdis input by a reference value listed in Table 2 for the comfort setting. For example, if the comfort setting is “2”, then controller 50 determines whether Tevap is greater than EngTdis by at least 10° F. Further, in decision block 130, controller 50 determines whether relative humidity input 53 is greater than the reference relative humidity listed in Table 2 for the comfort setting. For example, if the comfort setting is “1”, then controller 50 determines whether relative humidity input 53 is greater than 65%. Further, in decision block 130, controller 50 determines whether fog probability input 51 is greater than the reference fog probability value listed in Table 2 for the comfort setting. For example, if the comfort setting is “3”, then controller 50 determines whether fog probability input is greater than 65%. If any one of the Tamb, Tevap, relative humidity, or fog probability comparisons is true in decision block 130, then controller 50 outputs an engine “on” command 76 and an A/C compressor “on” command 78 as shown in block 132. The net result is that both engine 40 and A/C compressor 37 are turned on. The process then returns to decision block 122. If none the comparisons are true in decision block 130, then the process returns to decision block 122.

If controller 50 determines that HVAC system 20 is not in the maximum A/C mode in decision block 128, then the controller determines whether the HVAC system is in the defrost mode in decision block 134. If controller 50 determines that HVAC system 20 is in the defrost mode, then the controller processes HVAC comfort setting input 54 to determine the comfort setting of HVAC system 20. In general, controller 50 compares the various noted inputs with reference values set forth in the following Table 4 to determine whether to command engine 40 to start running for operation of A/C compressor 37.

TABLE 4
(Defrost Mode)

| | | | Tevap by (° F.) > | |
|---|---|---|---|---|
| Comfort Set. | Tamb(° F.) | % R.H. | EngTdisTarget | Fog Prob. |
| 0 | 32 | 25% | 25 | 15% |
| 1 | 32 | 25% | 15 | 15% |
| 2 | 32 | 25% | 10 | 15% |
| 3 | 32 | 25% | 5 | 15% |

Controller 50 then proceeds processing the various inputs in the manner as described with respect to the maximum A/C mode except that Table 4 reference values are used instead of Table 2 reference values. Particularly, in decision block 136, controller 50 determines whether Tamb input 56 is greater than the reference Tamb listed in Table 4 for the comfort setting of HVAC system 20, whether Tevap input 72 is at least greater in ° F. than the EngTdis input 74 by a reference value listed in Table 4 for the comfort setting, whether the relative humidity input 53 is greater than the reference relative humidity listed in Table 4 for the comfort setting, or whether fog probability input 51 is greater than the reference fog probability listed in Table 4 for the comfort setting. If in decision block 136 either the Tamb comparison, the Tevap comparison, the relative humidity comparison, or the fog probability comparison is true, then controller 50 outputs an engine “on” command 76 and an A/C compressor “on” command 78 as shown in block 132 and the process returns to decision block 122. If none of the comparisons are true in decision block 136, then the process returns to decision block 122.

If controller 50 determines that HVAC system 20 is not in the defrost mode in decision block 134, then the controller determines whether the HVAC system is in the floor/defrost mode in decision block 138. If controller 50 determines that HVAC system 20 is in the floor/defrost mode, then the controller processes HVAC comfort setting input 54 to determine the comfort setting of HVAC system 20. In general, controller 50 compares the various noted inputs with reference values set forth in the following Table 6 to determine whether to command engine 40 to start running for operation of A/C compressor 37.

TABLE 6
(Floor/Defrost Mode)

| | | | Tevap by (° F.) > | |
|---|---|---|---|---|
| Comfort Set. | Tamb(° F.) | % R.H. | EngTdisTarget | Fog Prob. |
| 0 | 32 | 25% | 25 | 15% |
| 1 | 32 | 25% | 15 | 15% |
| 2 | 32 | 25% | 10 | 15% |
| 3 | 32 | 25% | 5 | 15% |

Controller 50 then proceeds processing the various inputs in the manner as described with respect to the maximum A/C mode except that Table 6 reference values are used instead of Table 2 reference values. Particularly, in decision block 140, controller 50 determines whether Tamb input 56 is greater than the reference Tamb listed in Table 6 for the comfort setting of HVAC system 20, whether Tevap input 72 is at least greater in ° F. than the EngTdis input 74 by a reference value listed in Table 6 for the comfort setting, whether the relative humidity input 53 is greater than the reference relative humidity listed in Table 6 for the comfort setting, or whether fog probability input 51 is greater than the reference fog probability listed in Table 6 for the comfort setting. If in decision block 140, anyone of these four comparisons is true, then controller 50 outputs an engine “on” command 76 and an A/C compressor “on” command 78 as shown in block 132 and the process then returns to decision block 122. If none of the comparisons are true in decision block 140, then the process returns to decision block 122.

If controller 50 determines that HVAC system 20 is not in the floor/defrost mode in decision block 138, then the controller determines whether the HVAC system is in the automatic mode in decision block 142. If controller 50 determines that HVAC system 20 is in the automatic mode, then the controller processes HVAC comfort setting input 54 to determine the comfort setting of HVAC system 20. In general, controller 50 compares the various noted inputs with reference values set forth in the following Table 8 to determine whether to command engine 40 to start running for operation of A/C compressor 37.

TABLE 8
(Automatic Mode)

| | | | Tevap by (° F.) > | |
|---|---|---|---|---|
| Comfort Set. | Tamb(° F.) | % R.H. | EngTdisTarget | Fog Prob. |
| 0 | 80 | 75% | 30 | 80% |
| 1 | 75 | 70% | 20 | 75% |
| 2 | 70 | 65% | 10 | 70% |
| 3 | 60 | 60% | 5 | 65% |

Controller 50 then proceeds processing the various inputs in the manner as described with respect to the maximum A/C mode except that Table 8 reference values are used instead of Table 2 reference values. Particularly, in decision block 144, controller 50 determines whether Tamb input 56 is greater than the reference Tamb listed in Table 8 for the comfort setting of HVAC system 20, whether Tevap input 72 is at least greater in ° F. than the EngTdis input 74 by a reference value listed in Table 8 for the comfort setting, whether the relative humidity input 53 is greater than the reference relative humidity listed in Table 8 for the comfort setting, or whether fog probability input 51 is greater than the reference fog probability listed in Table 8 for the comfort setting. If in decision block 144, anyone of these four comparisons is true, then controller 50 outputs an engine “on” command 76 and an A/C compressor “on” command 78 as shown in block 132 and the process then returns to decision block 122. If none of the comparisons are true in decision block 144, then the process returns to decision block 122.

If controller 50 determines that HVAC system 20 is not in the automatic mode in decision block 142, then the controller determines whether the HVAC system is in either the panel, panel/floor, or floor mode in decision block 146. If controller 50 determines that HVAC system 20 is in either of these modes, then the controller processes HVAC comfort setting input 54 to determine the comfort setting of HVAC system 20. In general, controller 50 compares the various noted inputs with reference values set forth in the following Table 10 to determine whether to command engine 40 to start running for operation of A/C compressor 37.

TABLE 10
(Panel, Panel/Floor, Floor Modes)

| | | | Tevap by (° F.) > | |
|---|---|---|---|---|
| Comfort Set. | Tamb(° F.) | % R.H. | EngTdisTarget | Fog Prob. |
| 0 | 80 | 75% | 30 | 80% |
| 1 | 75 | 70% | 20 | 75% |
| 2 | 70 | 65% | 10 | 70% |
| 3 | 60 | 60% | 5 | 65% |

Controller 50 then proceeds processing the various inputs in the manner as described with respect to the maximum A/C mode except that Table 10 reference values are used instead of Table 2 reference values. Particularly, in decision block 148, controller 50 determines whether Tamb input 56 is greater than the reference Tamb listed in Table 10 for the comfort setting of HVAC system 20, whether Tevap input 72 is at least greater in ° F. than the EngTdis input 74 by a reference value listed in Table 10 for the comfort setting, whether the relative humidity input 53 is greater than the reference relative humidity listed in Table 10 for the comfort setting, or whether fog probability input 51 is greater than the reference fog probability listed in Table 10 for the comfort setting. If in decision block 148, anyone of these four comparisons is true, then controller 50 outputs an engine “on” command 76 and an A/C compressor “on” command 78 as shown in block 132 and the process then returns to decision block 122. If none of the comparisons are true in decision block 148, then the process returns to decision block 122.

If controller 50 determines that HVAC system 20 is not in either the panel, panel/floor, or floor mode in decision block 146, then the controller outputs an engine “off” command 76 as shown in block 126. The net result is that engine 40 (and thereby A/C compressor 37) remain turned off. The process then returns to decision block 122.

While controller 40 determines at decision block 122 that engine 40 is not running (and thereby that A/C compressor 37 is turned off), the controller outputs the climate action outputs 80, 82, 84, 86, and 88 for controlling other elements of HVAC system 20 in order to delay loss of cooling comfort while the A/C compressor is turned off as shown by block 147.

If controller 50 determines at decision block 122 that engine 40 is running, then the controller proceeds at block 149 to flow chart 90 (shown in FIG. 3) to determine whether to keep the engine running for operation of A/C compressor 37.

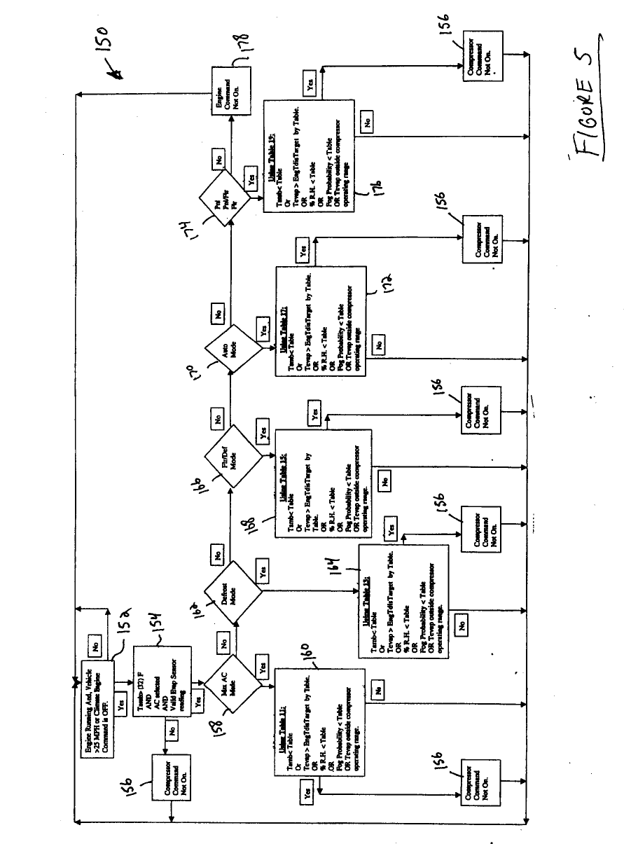

Referring now to FIG. 5, with continual reference to FIG. 3, a flow chart 150 describing operation of a flow strategy employed by controller 50 for deciding when to keep A/C compressor 37 running is shown. Flow chart 150 comes into play while A/C compressor 37 is running upon controller 50 determining at decision block 92 of FIG. 3 that engine 40 is running and either the vehicle speed is greater than 25 miles per hour or the climate engine command is turned off as shown in decision block 152 of flow chart 150. If either of these two conditions are true, then controller 50 processes HVAC mode input 52, Tamb input 56, and Tevap input 72 to respectively determine if “AC” is selected, if the ambient temperature is at least 32° F., and if the evaporator temperature is a valid reading as shown in decision block 154. If at least one of these conditions is not satisfied, then controller 50 outputs an A/C compressor “off” command 78 as shown in block 156. The net result is that A/C compressor 37 is turned off. The process then returns to decision block 152.

If “AC” is selected, Tamb is at least 32° F., and the Tevap reading is valid in decision block 154, then controller 50 processes HVAC mode input 52 to determine the mode of HVAC system 20. If controller 50 determines that HVAC system 20 is in the maximum A/C mode at decision block 158, then the controller processes HVAC comfort setting input 54 to determine the comfort setting of HVAC system 20. In general, controller 50 compares the various noted inputs (ambient temperature (Tamb) input 56, evaporator temperature (Tevap) input 72, engine discharge temperature (EngTdis) input 74, relative humidity (% R.H.) input 53, and fog probability input 51) with reference values set forth in the following Table 11 to determine whether or not to keep A/C compressor 37 running.

TABLE 11
(Maximum A/C Mode)

| Comfort | Tamb | % | Tevap by (° F.) > | Fog |
|---|---|---|---|---|
| Set. | (° F.) | R.H. | EngTdisTarget | Prob. |
| 0 | 70 | 55% | 0 | 70% |
| 1 | 65 | 50% | −5 | 65% |
| 2 | 60 | 45% | −10 | 60% |
| 3 | 50 | 40% | −15 | 55% |

As such, in decision block 160, controller 50 determines whether Tamb input 56 is less than the reference Tamb listed in Table 11 for the comfort setting of HVAC system 20. Further, in decision block 160, controller 50 compares Tevap input 72 to EngTdis input 74 to determine if the evaporator temperature is at least greater in ° F. than the engine discharge temperature by a reference value listed in Table 11 for the comfort setting. Further, in decision block 160, controller 50 determines whether relative humidity input 53 is less than the reference relative humidity listed in Table 11 for the comfort setting. Further, in decision block 160, controller 50 determines whether fog probability input 51 is less than the reference fog probability listed in Table 11 for the comfort setting. Further, in decision block 160, controller 50 determines whether the evaporator temperature is outside of a temperature operating range of A/C compressor 37. If any one of these five comparisons is true in decision block 160 (namely, the Tamb comparison, the first Tevap comparison, the relative humidity comparison, the fog probability comparison, or the second Tevap comparison), then controller 50 outputs an A/C compressor “off” command 78 as shown in block 156 and the process returns to decision block 152. If none of the comparisons are true in decision block 160, then the process returns to decision block 152.

If controller 50 determines that HVAC system 20 is not in the maximum A/C mode in decision block 158, then the controller determines whether the HVAC system is in the defrost mode in decision block 162. If controller 50 determines that HVAC system 20 is in the defrost mode, then the controller processes HVAC comfort setting input 54 to determine the comfort setting of HVAC system 20. In general, controller 50 compares the various noted inputs with reference values set forth in the following Table 13 to determine whether or not to keep A/C compressor 37 running.

TABLE 13
(Defrost Mode)

| | | | Tevap by (° F.) > | |
|---|---|---|---|---|
| Comfort Set. | Tamb (° F.) | % R.H. | EngTdisTarget | Fog Prob. |
| 0 | 27 | 20% | 5 | 5% |
| 1 | 27 | 20% | −5 | 5% |
| 2 | 27 | 20% | −10 | 5% |
| 3 | 27 | 20% | −15 | 5% |

Controller 50 then proceeds processing the various inputs in the manner as described with respect to the maximum A/C mode except that Table 13 reference values are used instead of Table 11 reference values. Particularly, in decision block 164, controller 50 determines whether Tamb input 56 is less than the reference Tamb listed in Table 13 for the comfort setting of HVAC system 20, whether Tevap input 72 is at least greater in ° F. than EngTdis input 74 by the reference listed in Table 13 for the comfort setting, whether relative humidity input 53 is less than the reference relative humidity listed in Table 13 for the comfort setting, whether fog probability input 51 is less than the reference fog probability listed in Table 13 for the comfort setting, or whether Tevap is outside of a temperature operating range of A/C compressor 37. If any of these five comparisons are true in decision block 164, then controller 50 outputs an A/C compressor “off” command 78 as shown in block 156 and the process returns to decision block 152. If none of the comparisons are true in decision block 164, then the process returns to decision block 152.

If controller 50 determines that HVAC system 20 is not in the defrost mode in decision block 162, then the controller determines whether the HVAC system is in the floor/defrost mode in decision block 166. If controller 50 determines that HVAC system 20 is in the floor/defrost mode, then the controller processes HVAC comfort setting input 54 to determine the comfort setting of HVAC system 20. In general, controller 50 compares the various noted inputs with reference values set forth in the following Table 15 to determine whether or not to keep A/C compressor 37 running.

TABLE 15
(Floor/Defrost Mode)

| | | | Tevap by (° F.) > | |
|---|---|---|---|---|
| Comfort Set. | Tamb (° F.) | % R.H. | EngTdisTarget | Fog Prob. |
| 0 | 27 | 20% | 5 | 5% |
| 1 | 27 | 20% | −5 | 5% |
| 2 | 27 | 20% | −10 | 5% |
| 3 | 27 | 20% | −15 | 5% |

Controller 50 then proceeds processing the various inputs in the manner as described with respect to the maximum A/C mode except that Table 15 reference values are used instead of Table 11 reference values. Particularly, in decision block 168, controller 50 determines whether Tamb input 56 is less than the reference Tamb listed in Table 15 for the comfort setting of HVAC system 20, whether Tevap input 72 is at least greater in ° F. than EngTdis input 74 by the reference value listed in Table 15 for the comfort setting, whether relative humidity input 53 is less than the reference relative humidity listed in Table 15 for the comfort setting, whether fog probability input 51 is less than the reference fog probability listed in Table 15 for the comfort setting, or whether Tevap is outside of a temperature operating range of A/C compressor 37. If any of these five comparisons are true in decision block 168, then controller 50 outputs an A/C compressor “off” command 78 as shown in block 156 and the process returns to decision block 152. If none of the comparisons are true in decision block 168, then the process returns to decision block 152.

If controller 50 determines that HVAC system 20 is not in the floor/defrost mode in decision block 166, then the controller determines whether the HVAC system is in the automatic mode in decision block 170. If controller 50 determines that HVAC system 20 is in the automatic mode, then the controller processes HVAC comfort setting input 54 to determine the comfort setting of HVAC system 20. In general, controller 50 compares the various noted inputs with reference values set forth in the following Table 17 to determine whether or not to keep A/C compressor 37 running.

TABLE 17
(Automatic Mode)

| | | | Tevap by (° F.) > | |
|---|---|---|---|---|
| Comfort Set. | Tamb (° F.) | % R.H. | EngTdisTarget | Fog Prob. |
| 0 | 70 | 55% | 10 | 70% |
| 1 | 65 | 50% | 0 | 65% |
| 2 | 60 | 45% | −10 | 60% |
| 3 | 55 | 40% | −15 | 55% |

Controller 50 then proceeds processing the various inputs in the manner as described with respect to the maximum A/C mode except that Table 17 reference values are used instead of Table 11 reference values. Particularly, in decision block 172, controller 50 determines whether Tamb input 56 is less than the reference Tamb listed in Table 17 for the comfort setting of HVAC system 20, whether Tevap input 72 is at least greater in ° F. than EngTdis input 74 by the reference value listed in Table 17 for the comfort setting, whether relative humidity input 53 is less than the reference relative humidity listed in Table 17 for the comfort setting, whether fog probability input 51 is less than the reference fog probability listed in Table 17 for the comfort setting, or whether Tevap is outside of a temperature operating range of A/C compressor 37. If any of these five comparisons are true in decision block 172, then controller 50 outputs an A/C compressor “off” command 78 as shown in block 156 and the process returns to decision block 152. If none of the comparisons are true in decision block 172, then the process returns to decision block 152.

If controller 50 determines that HVAC system 20 is not in the automatic mode in decision block 174, then the controller determines whether the HVAC system is in either the panel, panel/floor, or floor modes in decision block 174. If controller 50 determines that HVAC system 20 is any one of these modes, then the controller processes HVAC comfort setting input 54 to determine the comfort setting of HVAC system 20. In general, controller 50 compares the various noted inputs with reference values set forth in the following Table 19 to determine whether or not to keep A/C compressor 37 running.

TABLE 19
(Panel, Panel/Floor, Floor Modes)

| | | | Tevap by (° F.) > | |
|---|---|---|---|---|
| Comfort Set. | Tamb (° F.) | % R.H. | EngTdisTarget | Fog Prob. |
| 0 | 70 | 60% | 10 | 70% |
| 1 | 65 | 55% | 0 | 65% |
| 2 | 60 | 50% | −10 | 60% |
| 3 | 55 | 45% | −15 | 55% |

Controller 50 then proceeds processing the various inputs in the manner as described with respect to the maximum A/C mode except that Table 19 reference values are used instead of Table 11 reference values. Particularly, in decision block 176, controller 50 determines whether Tamb input 56 is less than the reference Tamb listed in Table 19 for the comfort setting of HVAC system 20, whether Tevap input 72 is at least greater in ° F. than EngTdis input 74 by the reference value listed in Table 19 for the comfort setting, whether relative humidity input 53 is less than the reference relative humidity listed in Table 19 for the comfort setting, whether fog probability input 51 is less than the reference fog probability listed in Table 19 for the comfort setting, or whether Tevap is outside of a temperature operating range of A/C compressor 37. If any of these five comparisons are true in decision block 176, then controller 50 outputs an A/C compressor “off” command 78 as shown in block 156 and the process returns to decision block 152. If none of the comparisons are true in decision block 176, then the process returns to decision block 152.

If controller 50 determines that HVAC system 20 is not in either the panel, panel/floor, or floor mode in decision block 174, then the controller outputs an A/C compressor “off” command 78 to thereby turn off A/C compressor 37 as shown in block 178 and the process then returns to decision block 152.

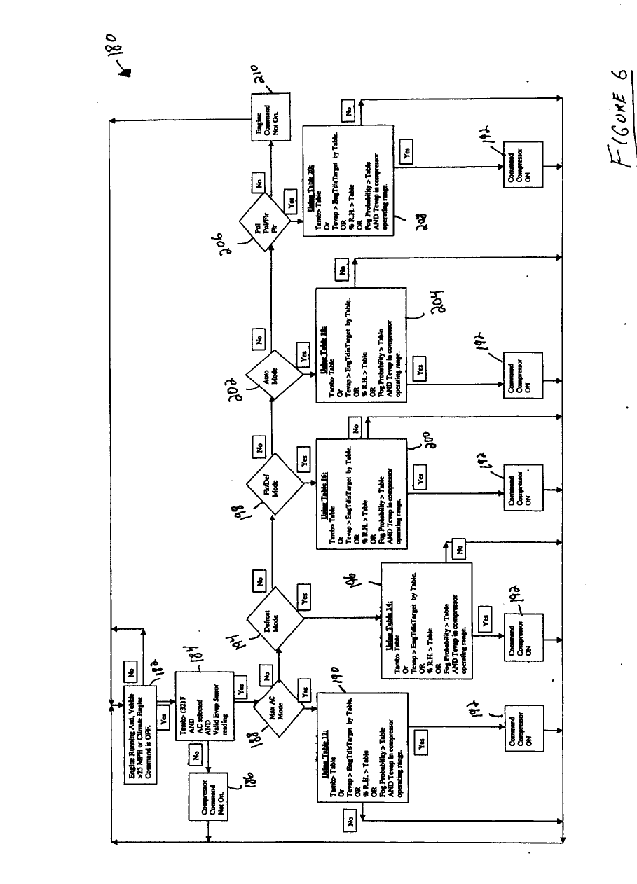

Referring now to FIG. 6, with continual reference to FIGS. 3 and 5, a flow chart 180 describing operation of a flow strategy employed by controller 50 for deciding when to command the A/C compressor to start running is shown. Flow chart 150 comes into play while A/C compressor 37 is off upon controller 50 determining at decision block 92 of flow chart 90 of FIG. 3 that engine 40 is running and either the vehicle speed is greater than 25 miles per hour or the climate engine command is turned off as shown in decision block 182 of flow chart 180. If either of these two conditions are true, then controller 50 processes HVAC mode input 52, Tamb input 56, and Tevap input 72 to respectively determine if “AC” is selected, if the ambient temperature is at least 32° F., and if the evaporator temperature is a valid reading as shown in decision block 184. If at least one of these conditions is not satisfied, then controller 50 outputs an A/C compressor “off” command 78 as shown in block 186. The net result is that A/C compressor 37 remains turned off. The process then returns to decision block 182.

If “AC” is selected, Tamb is at least 32° F., and the Tevap reading is valid in decision block 184, then controller 50 processes HVAC mode input 52 to determine the mode of HVAC system 20. If controller 50 determines that HVAC system 20 is in the maximum A/C mode at decision block 188, then the controller processes HVAC comfort setting input 54 to determine the comfort setting of HVAC system 20. In general, controller 50 compares the various noted inputs (ambient temperature (Tamb) input 56, evaporator temperature (Tevap) input 72, engine discharge temperature (EngTdis) input 74, relative humidity (% R.H.) input 53, and fog probability input 51) with reference values set forth in the following Table 12 to determine whether to command A/C compressor 37 to start running.

TABLE 12
(Maximum A/C Mode)

| | | | Tevap by (° F.) > | |
|---|---|---|---|---|
| Comfort Set. | Tamb (° F.) | % R.H. | EngTdisTarget | Fog Prob. |
| 0 | 80 | 70% | 20 | 80% |
| 1 | 75 | 65% | 15 | 75% |
| 2 | 70 | 60% | 10 | 70% |
| 3 | 60 | 55% | 5 | 65% |

As such, in decision block 190, controller 50 determines whether Tamb input 56 is greater than the reference Tamb listed in Table 12 for the comfort setting of HVAC system 20. Further, in decision block 190, controller 50 compares Tevap input 72 to EngTdis input 74 to determine if the evaporator temperature is at least greater in ° F. than the engine discharge temperature by a reference value listed in Table 12 for the comfort setting. Further, in decision block 190, controller 50 determines whether relative humidity input 53 is greater than the reference relative humidity listed in Table 12 for the comfort setting. Further, in decision block 190, controller 50 determines whether fog probability input 51 is greater than the reference fog probability listed in Table 12 for the comfort setting. Further, in decision block 190, controller 50 determines whether Tevap is within a temperature operating range of A/C compressor 37. If this last comparison is true and if any of the four previous comparisons is true, then controller 50 outputs an A/C compressor “on” command 76 as shown in block 192 with the net effect being that A/C compressor 37 starts running. The process then returns to decision block 182.

If controller 50 determines that HVAC system 20 is not in the maximum A/C mode in decision block 188, then the controller determines whether the HVAC system is in the defrost mode in decision block 194. If controller 50 determines that HVAC system 20 is in the defrost mode, then the controller processes HVAC comfort setting input 54 to determine the comfort setting of HVAC system 20. In general, controller 50 compares the various noted inputs with reference values set forth in the following Table 14 to determine whether to command A/C compressor 37 to start running.

TABLE 14
(Defrost Mode)

| | | | Tevap by (° F.) > | |
|---|---|---|---|---|
| Comfort Set. | Tamb (° F.) | % R.H. | EngTdisTarget | Fog Prob. |
| 0 | 32 | 25% | 25 | 15% |
| 1 | 32 | 25% | 15 | 15% |
| 2 | 32 | 25% | 10 | 15% |
| 3 | 32 | 25% | 5 | 15% |

As such, in decision block 196, controller 50 determines whether Tamb input 56 is greater than the reference Tamb value listed in Table 14 for the comfort setting of HVAC system 20, whether the evaporator temperature is at least greater in ° F. than the engine discharge temperature by a reference value listed in Table 14 for the comfort setting, whether relative humidity input 53 is greater than the reference relative humidity listed in Table 14 for the comfort setting, or whether fog probability input 51 is greater than the reference fog probability value listed in Table 14 for the comfort setting. Further, in decision block 196, controller 50 determines whether the evaporator temperature is within a temperature operating range of A/C compressor 37. If this last comparison is true and if anyone of the four previous comparisons is true, then controller 50 outputs an A/C compressor “on” command 76 as shown in block 192 with the net effect being that A/C compressor 37 starts running. The process then returns to decision block 182.

If controller 50 determines that HVAC system 20 is not in the defrost mode in decision block 194, then the controller determines whether the HVAC system is in the floor/defrost mode in decision block 198. If controller 50 determines that HVAC system 20 is in the floor/defrost mode, then the controller processes HVAC comfort setting input 54 to determine the comfort setting of HVAC system 20. In general, controller 50 compares the various noted inputs with reference values set forth in the following Table 16 to determine whether to command A/C compressor 37 to start running.

TABLE 16
(Floor/Defrost Mode)

| | | | Tevap by (° F.) > | |
|---|---|---|---|---|
| Comfort Set. | Tamb (° F.) | % R.H. | EngTdisTarget | Fog Prob. |
| 0 | 32 | 25% | 25 | 15% |
| 1 | 32 | 25% | 15 | 15% |
| 2 | 32 | 25% | 10 | 15% |
| 3 | 32 | 25% | 5 | 15% |

As such, in decision block 200, controller 50 determines whether Tamb input 56 is greater than the reference Tamb listed in Table 16 for the comfort setting of HVAC system 20, whether the evaporator temperature is at least greater in ° F. than the engine discharge temperature by a reference value listed in Table 16 for the comfort setting, whether relative humidity input 53 is greater than the reference relative humidity listed in Table 16 for the comfort setting, or whether fog probability input 51 is greater than the reference fog probability listed in Table 16 for the comfort setting. Further, in decision block 200, controller 50 determines whether the evaporator temperature is within a temperature operating range of A/C compressor 37. If this last comparison is true and if anyone of the four previous comparisons is true, then controller 50 outputs an A/C compressor “on” command 76 as shown in block 192 with the net effect being that A/C compressor 37 starts running. The process then returns to decision block 182.

If controller 50 determines that HVAC system 20 is not in the floor/defrost mode in decision block 198, then the controller determines whether the HVAC system is in the automatic in decision block 202. If controller 50 determines that HVAC system 20 is in the automatic mode, then the controller processes HVAC comfort setting input 54 to determine the comfort setting of HVAC system 20. In general, controller 50 compares the various noted inputs with reference values set forth in the following Table 18 to determine whether to command A/C compressor 37 to start running.

TABLE 18
(Automatic Mode)

| | | | Tevap by (° F.) > | |
|---|---|---|---|---|
| Comfort Set. | Tamb (° F.) | % R.H. | EngTdisTarget | Fog Prob. |
| 0 | 80 | 75% | 30 | 80% |
| 1 | 75 | 70% | 20 | 75% |
| 2 | 70 | 65% | 10 | 70% |
| 3 | 60 | 60% | 5 | 65% |

As such, in decision block 202, controller 50 determines whether Tamb input 56 is greater than the reference Tamb value listed in Table 18 for the comfort setting of HVAC system 20, whether the evaporator temperature is at least greater in ° F. than the engine discharge temperature by a reference value listed in Table 18 for the comfort setting, whether relative humidity input 53 is greater than the reference relative humidity value listed in Table 18 for the comfort setting, or whether fog probability input 51 is greater than the reference fog probability listed in Table 18 for the comfort setting. Further, in decision block 204, controller 50 determines whether the evaporator temperature is within a temperature operating range of A/C compressor 37. If this last comparison is true and if anyone of the four previous comparisons is true, then controller 50 outputs an A/C compressor “on” command 76 as shown in block 192 with the net effect being that A/C compressor 37 starts running. The process then returns to decision block 182.

If controller 50 determines that HVAC system 20 is not in the automatic mode in decision block 202, then the controller determines whether the HVAC system is in either the panel, panel/floor, or floor modes in decision block 206. If controller 50 determines that HVAC system 20 is in either one of these modes, then the controller processes HVAC comfort setting input 54 to determine the comfort setting of HVAC system 20. In general, controller 50 compares the various noted inputs with reference values set forth in the following Table 20 to determine whether to command A/C compressor 37 to start running.

TABLE 20
(Panel, Panel/Floor, Floor Modes)

| | | | Tevap by (° F.) > | |
|---|---|---|---|---|
| Comfort Set. | Tamb (° F.) | % R.H. | EngTdisTarget | Fog Prob. |
| 0 | 80 | 75% | 30 | 80% |
| 1 | 75 | 70% | 20 | 75% |
| 2 | 70 | 65% | 10 | 70% |
| 3 | 60 | 60% | 5 | 65% |

As such, in decision block 208, controller 50 determines whether Tamb input 56 is greater than the reference Tamb value listed in Table 20 for the comfort setting of HVAC system 20, whether the evaporator temperature is at least greater in ° F. than the engine discharge temperature by a reference value listed in Table 20 for the comfort setting, whether relative humidity input 53 is greater than the reference relative humidity value listed in Table 20 for the comfort setting, or whether fog probability input 51 is greater than the reference fog probability value listed in Table 20 for the comfort setting. Further, in decision block 208, controller 50 determines whether the evaporator temperature is within a temperature operating range of A/C compressor 37. If this last comparison is true and if any of the four previous comparisons is true, then controller 50 outputs an A/C compressor “on” command 76 as shown in block 192 with the net effect being that A/C compressor 37 starts running. The process then returns to decision block 182.

If controller 50 determines that HVAC system 20 is not in either the panel, panel/floor, or floor mode in decision block 206, then the controller outputs an A/C compressor “off” command 78 to thereby keep A/C compressor 37 off as shown in block 210 and the process then returns to decision block 182.

It is noted that when the conditions are such that either operations described with reference to flow charts 150 and 180 come into play the method and system of the present invention undertake climate hybrid economy actions. Such actions are undertaken to limit operation of A/C compressor 37 and to adjust the blend door to control reheat when the A/C compressor is off and restart the A/C compressor when the reheat is minimal.

While the best mode for carrying out the invention has been described in detail, those familiar with the art to which this invention relates will recognize various alternative designs and embodiments for practicing the invention as defined by the following claims.

What is claimed:

1. A method of operating a climate control system of a hybrid vehicle without the use of an A/C compressor of the climate control system, wherein the A/C compressor is turned on to function when the A/C compressor is coupled to an engine of the hybrid vehicle and the engine is running, the method comprising:
determining whether the hybrid vehicle is at idle or is being driven;
determining whether the engine of the hybrid vehicle is running;
monitoring relative humidity inside the cabin of the vehicle;
determining whether or not the A/C compressor is required to function by comparing the monitored relative humidity to a relative humidity threshold;
determining that the A/C compressor is required to function if the monitored relative humidity is less than the relative humidity threshold;
if the engine is running and if the A/C compressor is off, turning on the A/C compressor if the A/C compressor is required to function;
determining that the A/C compressor is not required to function if the monitored relative humidity is greater than the relative humidity threshold;
if the engine is running, turning off the engine such that the A/C compressor is turned off if the A/C compressor is not required to function and if the vehicle is at idle; and
if the A/C compressor was on, turning off the A/C compressor without turning off the engine if the A/C compressor is not required to function and if the vehicle is being driven.

2. The method of claim 1 further comprising:
determining fog probability of a vehicle window;
wherein determining whether or not the A/C compressor is required to function includes comparing the determined fog probability with a fog probability threshold;
determining that the A/C compressor is required to function if the determined fog probability is less than the fog probability threshold;
determining that the A/C compressor is not required to function if the determined fog probability is greater than the fog probability threshold.

3. The method of claim 1 further comprising:
determining a comfort setting of the climate control system;
wherein determining whether or not the A/C compressor is required to function includes comparing the monitored relative humidity to a relative humidity threshold associated with the comfort setting of the climate control system;
determining that the A/C compressor is required to function if the monitored relative humidity is less than the relative humidity threshold associated with the comfort setting of the climate control system; and
determining that the A/C compressor is not required to function if the monitored relative humidity is greater than the relative humidity threshold associated with the comfort setting of the climate control system.

4. The method of claim 2 further comprising:
determining a comfort setting of the climate control system;
wherein determining whether or not the A/C compressor is required to function includes comparing the determined fog probability with a fog probability threshold associated with the comfort setting of the climate control system;
determining that the A/C compressor is required to function if the determined fog probability is less than the fog probability threshold associated with the comfort setting of the climate control system;
determining that the A/C compressor is not required to function if the determined fog probability is greater than the fog probability threshold associated with the comfort setting of the climate control system.

5. The method of claim 1 further comprising:
determining an operating mode of the climate control system;
wherein determining whether or not the A/C compressor is required to function includes comparing the monitored relative humidity to a relative humidity threshold associated with the operating mode of the climate control system;
determining that the A/C compressor is required to function if the monitored relative humidity is less than the relative humidity threshold associated with the operating mode of the climate control system; and
determining that the A/C compressor is not required to function if the monitored relative humidity is greater than the relative humidity threshold associated with the operating mode of the climate control system.

6. The method of claim 3 further comprising:
determining an operating mode of the climate control system;
wherein determining whether or not the A/C compressor is required to function includes comparing the determined fog probability with a fog probability threshold associated with the operating mode of the climate control system;
determining that the A/C compressor is required to function if the determined fog probability is less than the fog probability threshold associated with the operating mode of the climate control system;
determining that the A/C compressor is not required to function if the determined fog probability is greater than the fog probability threshold associated with the operating mode of the climate control system.

7. The method of claim 1
determining a comfort setting and an operating mode of the climate control system;
wherein determining whether or not the A/C compressor is required to function includes comparing the monitored relative humidity to a relative humidity threshold associated with the comfort setting and the operating mode of the climate control system;
determining that the A/C compressor is required to function if the monitored relative humidity is less than the relative humidity threshold associated with the comfort setting and the operating mode of the climate control system; and
determining that the A/C compressor is not required to function if the monitored relative humidity is greater than the relative humidity threshold associated with the comfort setting and the operating mode of the climate control system.

8. The method of claim 2 further comprising:
determining a comfort setting and an operating mode of the climate control system;
wherein determining whether or not the A/C compressor is required to function includes comparing the determined fog probability with a fog probability threshold associated with the comfort setting and the operating mode of the climate control system;
determining that the A/C compressor is required to function if the determined fog probability is less than the fog probability threshold associated with the comfort setting and the operating mode of the climate control system;
determining that the A/C compressor is not required to function if the determined fog probability is greater than the fog probability threshold associated with the comfort setting and the operating mode of the climate control system.

9. The method of claim 1 further comprising:
operating elements of the climate control system while the A/C compressor is off in order to delay loss of air conditioning comfort in the cabin of the vehicle.

10. The method of claim 1 wherein if the engine was not running, the method further comprising:
determining whether or not the engine is to be turned on for the A/C compressor to function by comparing the monitored relative humidity to a second relative humidity threshold;
determining that the A/C compressor is required to function if the monitored relative humidity is greater than the second relative humidity threshold; and
turning on the engine to thereby turn on the A/C compressor if the A/C compressor is required to function.

11. The method of claim 10 further comprising:
monitoring fog probability of a vehicle window;
wherein determining whether or not the A/C compressor is required to function includes comparing the monitored fog probability with a fog probability threshold;
determining that the A/C compressor is required to function if the monitored fog probability is less than the fog probability threshold;
determining that the A/C compressor is not required to function if the monitored fog probability is greater than the fog probability threshold.

12. The method of claim 11 wherein if the engine was not running, the method further comprising:
determining whether or not the engine is to be turned on for the A/C compressor to function by comparing the monitored fog probability to a second fog probability threshold;
determining that the A/C compressor is required to function if the monitored fog probability is greater than the second fog probability threshold; and
turning on the engine to thereby turn on the A/C compressor if the A/C compressor is required to function.

13. The method of claim 10 further comprising:
determining a comfort setting of the climate control system;
wherein determining whether or not the engine is to be turned on for the A/C compressor to function by comparing the monitored relative humidity to a second relative humidity threshold associated with the comfort setting;
determining that the A/C compressor is required to function if the monitored relative humidity is greater than the second relative humidity threshold associated with the comfort setting; and
turning on the engine to thereby turn on the A/C compressor if the A/C compressor is required to function.

14. The method of claim 13 further comprising:
determining an operating mode of the climate control system;
wherein determining whether or not the engine is to be turned on for the A/C compressor to function by comparing the monitored relative humidity to a second relative humidity threshold associated with the comfort setting and the operating mode;
determining that the A/C compressor is required to function if the monitored relative humidity is greater than the second relative humidity threshold associated with the comfort setting and the operating mode; and
turning on the engine to thereby turn on the A/C compressor if the A/C compressor is required to function.

15. A method of operating a climate control system of a hybrid vehicle without the use of an A/C compressor of the climate control system, wherein the A/C compressor is turned on to function when the A/C compressor is coupled to an engine of the hybrid vehicle and the engine is running, the method comprising:
determining whether the hybrid vehicle is at idle or is being driven;
determining whether the engine of the hybrid vehicle is running;
monitoring fog probability of a vehicle window;
determining whether or not the A/C compressor is required to function by comparing the monitored fog probability to a fog probability threshold;
determining that the A/C compressor is required to function if the monitored fog probability is less than the fog probability threshold;
if the engine is running and if the A/C compressor is off, turning on the A/C compressor if the A/C compressor is required to function;
determining that the A/C compressor is not required to function if the monitored fog probability is greater than the fog probability threshold;
if the engine is running, turning off the engine such that the A/C compressor is turned off if the A/C compressor is not required to function and if the vehicle is at idle; and
if the A/C compressor was on, turning off the A/C compressor without turning off the engine if the A/C compressor is not required to function and if the vehicle is being driven.

16. The method of claim 15 wherein if the engine was not running, the method further comprising:
determining whether or not the engine is to be turned on for the A/C compressor to function by comparing the monitored fog probability to a second fog probability threshold;
determining that the A/C compressor is required to function if the monitored fog probability is greater than the second fog probability threshold; and
turning on the engine to thereby turn on the A/C compressor if the A/C compressor is required to function.

17. A climate control system of a hybrid vehicle, the system comprising:
an A/C compressor which couples to an engine of a hybrid vehicle when the engine is on in order to function; and
a controller for determining whether the hybrid vehicle is at idle or is being driven and whether the engine of the hybrid vehicle is running, wherein the controller determines whether the A/C compressor is required to function by comparing relative humidity monitored inside the vehicle cabin to a relative humidity threshold;
wherein the controller determines that the A/C compressor is required to function if the monitored relative humidity is less than the relative humidity threshold and determines that the A/C compressor is not required to function if the monitored relative humidity is greater than the relative humidity threshold;
wherein if the engine is running and if the A/C compressor is off, the controller turns on the A/C compressor if the A/C compressor is required to function;
wherein if the engine is running, the controller turns off the engine such that the A/C compressor is turned off if the A/C compressor is not required to function and if the vehicle is at idle; and
wherein if the A/C compressor was on, the controller turns off the A/C compressor without turning off the engine if the A/C compressor is not required to function and if the vehicle is being driven.
